(19) United States
(12) Patent Application Publication
(10) Pub. No.: US 2016/0126624 A1
(43) Pub. Date: May 5, 2016

(54) RADIO COMMUNICATION MODULE

(71) Applicant: SAMSUNG ELECTRO-MECHANICS CO., LTD., Suwon-si (KR)

(72) Inventors: Yong Hee LEE, Suwon-si (KR); Jong Yun KIM, Suwon-si (KR); Hyo Jin KIM, Suwon-si (KR); Won SEO, Suwon-si (KR); Kwang Ju CHOI, Suwon-si (KR)

(73) Assignee: SAMSUNG ELECTRO-MECHANICS CO., LTD., Suwon-si (KR)

(21) Appl. No.: 14/930,155

(22) Filed: Nov. 2, 2015

(30) Foreign Application Priority Data
Nov. 3, 2014 (KR) 10-2014-0151195

(51) Int. Cl. H01Q 1/52; H01Q 1/50

(52) U.S. Cl. CPC H01Q 1/526; H01Q 1/50

(57) ABSTRACT

A radio communication module includes: a printed circuit board; an external patch antenna electrically connected to the printed circuit board through connectors and a cable; a shield can disposed on a surface of the printed circuit board; and a cover assembled on a surface of the shield can and including a connector fixing portion protruding toward the connector.

### CROSS-REFERENCE TO RELATED APPLICATION(S)

This application claims the benefit of Korean Patent Application No. 10-2014-0151195 filed on Nov. 3, 2014 in the Korean Intellectual Property Office, the entire disclosure of which is incorporated herein by reference for all purposes.

### BACKGROUND

1. Field

The following description relates to a radio communication module.

2. Description of Related Art

Generally, Wi-Fi is a wireless LAN technology which may realize powerful radio communications by combining high fidelity with a wireless technology, in which the wireless LAN is a type of network constructed using a radio wave, light, or the like, without using a wired line.

Therefore, consumer electronics including a set top box, a television (TV), a printer, notebook computer, etc., may be used while being wirelessly connected by a radio communication module configured to perform radio communications, including Wi-Fi.

Here, the radio communication module includes an antenna which plays an important role for radio communications. That is, as disclosed in KR10-2007-0017087 A, an antenna connector is mounted on a printed circuit board of the radio communication module and a radio frequency cable connector is connected to the antenna connector to connect the antenna.

KR10-2007-0017087 A discloses that the antenna connector and the RF cable connector are each provided with protrusions and grooves to be coupled with each other, to thereby prevent the connectors from being separated.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

According to one general aspect, a radio communication module includes: a printed circuit board; an external patch antenna electrically connected to the printed circuit board through connectors and a cable; a shield can disposed on a surface of the printed circuit board; and a cover assembled on a surface of the shield can and including a connector fixing portion protruding toward the connector.

Ends of the cover may include assembling portions which are bent toward the shield can.

The cover may further include a reinforcing portion for reinforcing a strength of the connector fixing portion.

The reinforcing portion may include a rib formed at an outside portion of the connector fixing portion or a raised portion formed at an inside portion of the connector fixing portion.

The connectors may include a first connector disposed on the printed circuit board and a second connector formed on the cable, and the connector fixing portion may be configured to limit movement of the second connector.

According to another general aspect, a radio communication module includes: a printed circuit board; an external patch antenna electrically connected to the printed circuit board through connectors and a cable; a shield can disposed on a surface of the printed circuit board and having a side including a connector accommodating space in which the connector is disposed; and a cover attached to a surface of the shield can and covering the connector accommodating space.

The connector accommodating space may be disposed at a central part of the side of the shield can.

The connector accommodating space may be disposed at a central part of the side of the shield can.

The connectors may include a first connector disposed on the printed circuit board and a second connector formed on the cable, and the cover may be configured to limit movement of the second connector.

Other features and aspects will be apparent from the following detailed description, the drawings, and the claims.

### BRIEF DESCRIPTION OF DRAWINGS

FIG. 1 is an exploded perspective view illustrating an example of a radio communication module.

FIG. 2 is a plan view illustrating the radio communication module of FIG. 1.

FIG. 3 is a partially enlarged side cross-sectional view of the radio communication module of FIG. 1.

FIG. 4 is an exploded perspective view illustrating another example of a radio communication module.

FIG. 5 is a plan view illustrating the radio communication module of FIG. 4.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

A radio communication module according to example embodiments disclosed herein includes a printed circuit board (PCB) on which RF circuits for radio communications (including, for example, Wi-Fi or Bluetooth), various circuit devices, or the like are mounted, an external patch antenna (ANT) which is electrically connected to the printed circuit board (PCB) through connectors and a cable, a shield can which is assembled in the printed circuit board (PCB) to protect the circuit devices from electromagnetic waves, etc., and a cover which is provided on the shield can. The radio communication module is used while being embedded in consumer electronics including, for example, a set top box (STB), a television (TV), a printer, etc.

Meanwhile, when a consumer electronic device having a radio communication module embedded therein in a state in which the printed circuit board is connected to the external patch antenna through connectors is subjected to abnormal damage from the outside, or when the radio communication module is directly damaged, separation of the connectors may occur, and thus the antenna may be separated from the radio communication module.

According to example embodiments disclosed herein, to prevent the connectors from being separated due to damage while the radio communication module is embedded in the consumer electronic device, the connectors are secured using the shield can protecting the circuit devices disposed on the printed circuit board.

For example, when an internal metal antenna is soldered to a printed circuit board and the connectors are omitted, the soldered antenna is unlikely to be separated. However, when the antenna is extended to the outside of a consumer electronic device using the connectors and the cable to avoid isolation between antennas or to provide high performance, the connectors may be separated anytime due to damage.

Therefore, the radio communication module according to the embodiments disclosed herein includes a cover connected or bonded to the shield can provided on the printed circuit board, and configured to fix a position of the connectors connecting the external patch antenna to the printed circuit board to prevent the connectors from separating, thereby improving reliability of radio communications and preventing performance deterioration.

Hereinafter, example embodiments of a radio communication module will be described in detail with reference to the accompanying drawings.

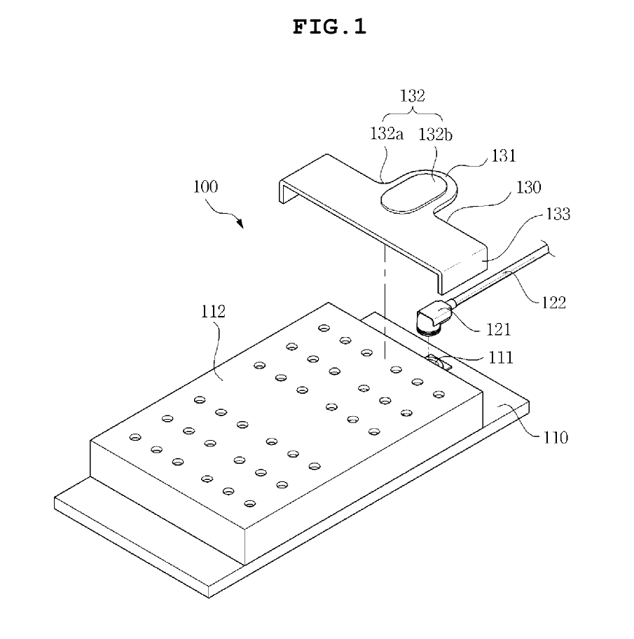

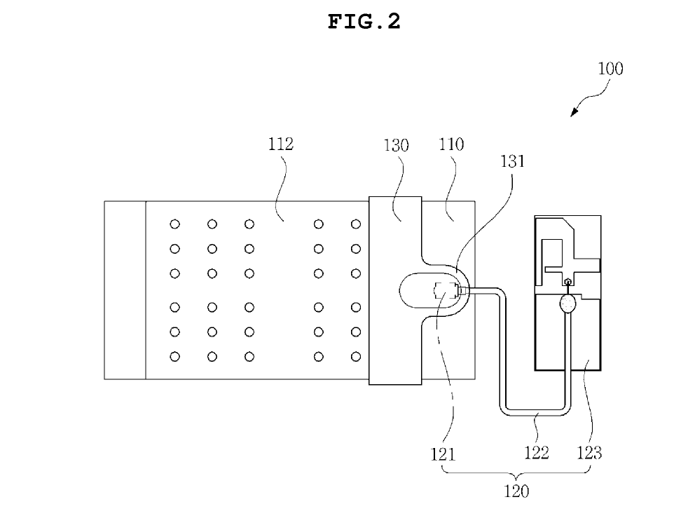

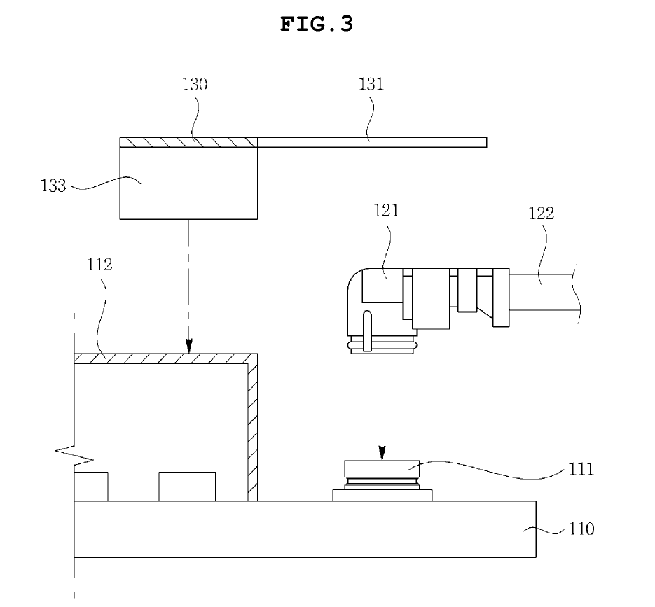

As illustrated in FIGS. 1 to 3, a radio communication module 100 according to an embodiment includes a printed circuit board (PCB) or substrate 110, an external patch antenna 120 which is electrically connected to the printed circuit board 110 through U.FL connectors 111 and 121 and a cable 122, a shield can 112 which is disposed on one surface of the printed circuit board 110 to have one or more circuit devices (not shown) accommodated therein, and a cover 130 which is provided on one surface of the shield can 112 to prevent the U.FL connectors 111 and 121 from being separated.

The printed circuit board 110 and the external patch antenna 120 are connected to each other through the U.FL connectors 111 and 121 which are formed in a male and female pair and, thus, are electrically connected to each other. Therefore, the printed circuit board 110 and the external patch antenna 120 may each include any one of the U.FL connectors 111 and 121. Hereinafter, the U.FL connector 111 provided on the printed circuit board 110 is referred to as the first connector 111 and the U.FL connector 121 provided on the external patch antenna 120 is referred to as the second connector 121.

That is, the first connector 111 is mounted on one surface of the printed circuit board 110. In this case, the printed circuit board 110 includes the shield can 112, which is constructed of a metal material and covers the circuit device(s) to protect the circuit device(s) from electromagnetic waves, etc., and may selectively include an interface, etc., through which the radio communication module 100 may be connected to an electronic device.

The external patch antenna 120 is configured as a kind of module by providing the second connector 121 at one end of the cable 122 and soldering the other end of the cable 122 to the antenna substrate 123 to be mounted in the antenna substrate 123.

The cover 130 is disposed on an upper surface of the shield can 112 to prevent separation of the first and second connectors 111 and 121, which are connected to each other at the outside of the shield can 112, by limiting movement of the second connector 121. To this end, the cover 130 includes a connector fixing portion 131 which is a separation preventing means and protrudes toward the first and second connectors 111 and 121 to be disposed over the first and second connectors 111 and 121.

That is, as shown in FIGS. 1-3, the connector fixing portion 131 is disposed on a right side of the cover 130 and protrudes toward the first and second connectors 111 and 121 in a position to limit movement of the second connector 121 up, down, left and right. Thus, it is possible to prevent the first and second connectors 111 and 121, which are formed in a female and male pair and are connected to each other, from being separated due to the movement of the cable 122 up, down, left, or right.

As shown in FIGS. 1-3, the right end of the connector fixing portion 131 may be depressed downward or may be bent in an opposite direction to thereby form a reinforcing portion 132 for reinforcing strength. That is, the reinforcing portion 132 is configured to structurally reinforce the strength of the connector fixing portion 131, which is generally formed in the shape of a thin plate, and the reinforcing portion 132 is implemented by forming a rib 132a on the cover 130 at an outside portion of the connector fixing portion 131.

The rib 132a is integrally formed between the cover 130 and the connector fixing portion 131 while the cover 130 is formed, for example, by press machining, thereby preventing the connector fixing portion 131 from being depressed, bent, or the like.

Further, the reinforcing portion 132 may be formed within the connector fixing portion 131, which may be easily implemented by bending a portion of the plate toward the printed circuit board 110 or an opposite direction to the printed circuit board 110 to form a bumped-out or raised portion 132b at an inside portion of the connector fixing portion 131 during the formation of the connector fixing portion 131. That is, the raised portion 132b structurally bends the connector fixing portion 131 to prevent the connector fixing portion 131 from being depressed or bent.

The reinforcing portion 132 may be configured to include any one of the rib 132a and the raised portion 132b and may also be configured to include both of the rib 132a and the raised portion 132b. Further, both ends of the cover 130 are provided with assembling portions 133 which are bent toward the shield can 112. That is, the assembling portion 133 may be easily assembled on an upper surface of the shield can 112 by a fitting method such as interference fitting or press fitting.

Therefore, the radio communication module 100 includes the connector fixing portion 131 which is a separation preventing means provided on the cover 130 and protruding toward the first and second connectors 111 and 121 to easily prevent the first and second connectors 111 and 121 from being separated by relative movement, thereby effectively fixing the positions of the first and second connectors 111 and 112 and preventing the performance deterioration.

The radio communication module 100 is manufactured, for example, by the following manufacturing method. First, the circuit device(s) and the first connector 111 for radio connection are disposed on the upper surface of the printed circuit board 110. Further, the shield can 112 is attached to the printed circuit board 110 to cover the circuit device(s).

Next, a soldering process is performed to mount the circuit device(s) and the first connector 111 on the printed circuit board 110 and fix the shield can 112 to the printed circuit board 110. When the soldering process is completed, the second connector 121 of the external patch antenna 120 is connected to the first connector 111 to electrically connect the external patch antenna 120 to the printed circuit board 110.

Finally, the cover 130 is assembled on the upper surface of the shield can 112 to dispose the connector fixing portion 131 over the first and second connectors 111 and 121, thereby preventing the first and second connectors 111 and 121 from being separated due to the movement of the cable 122.

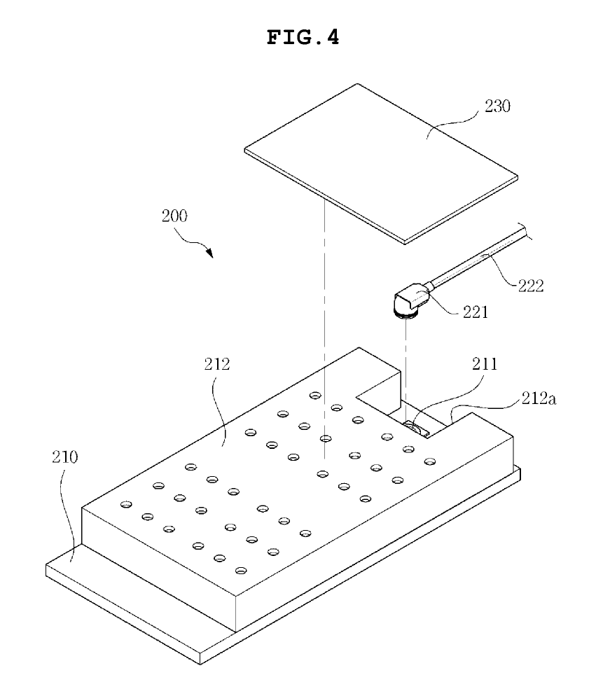

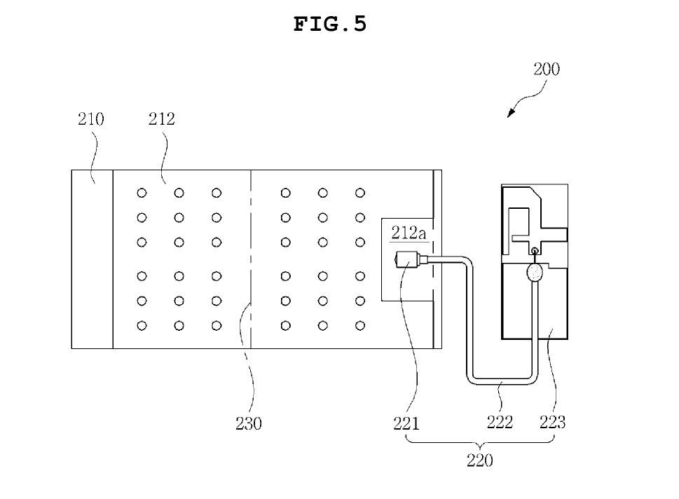

As illustrated in FIGS. 4 and 5, a radio communication module 200 according to another embodiment includes a substrate 210, an external patch antenna 220 which is electrically connected to the substrate 210 through first and second U.FL connectors 211 and 221 and the cable 222, and a shield can 212 which is provided on one surface of the printed circuit board 210. The shield can 212 has one or more circuit devices (not shown) accommodated therein, and has one side including a connector accommodating space 212a in which the first U.FL connector 211 is disposed on the substrate 210. A cover 230 is provided on the shield can 212 to cover the connector accommodating space 212a to prevent the first and second U.FL connectors 211 and 221 from being separated.

The substrate 210 and the external patch antenna 220 are connected to each other through the first and second U.FL connectors 211 and 221 which are formed in a male and female pair and thus are electrically connected to each other. Therefore, the substrate 210 and the external patch antenna 220 may each include any one of U.FL connectors 211 and 221.

That is, the first connector 211 the circuit device(s) for radio communications are mounted on one surface of the substrate 210. In this case, the printed circuit board 210 includes the shield can 212, which is constructed of a metal material and covers the circuit device(s) to protect the circuit device(s) from electromagnetic waves, etc., and may selectively include an interface, etc., through which the radio communication module 200 may be connected to an electronic device.

When viewed from the top in FIG. 5, the shield can 212 is formed in a [symbol] -letter shape on the whole and a right central part thereof is provided with the connector accommodating space 212a in which the first connector 211 is disposed.

The external patch antenna 220 is configured as a kind of module by providing the second connector 221 at one end of the cable 222 and soldering the other end of the cable 222 to the antenna substrate 223 to be mounted in the antenna substrate 223.

The cover 230 is provided on an upper surface of the shield can 212 to prevent the first and second connectors 211 and 221, which are disposed in the connector accommodating space 212a and connected to each other, from being separated. The cover 230 is, for example, bonded to the upper surface of the shield can 212 by a general adhesive tape to cover the connector accommodating space 212a, and is positioned to limit movement of the second connector 221, thereby preventing the first and second connectors 211 and 221 from being separated.

Therefore, the radio communication module 200 includes the connector accommodating space 212a formed in the shield can 212 and the cover 130, which is a separation preventing means for the first and second connectors 211 and 221 and covers the connector accommodating space 212a to easily prevent the first and second connectors 211 and 221 from being separated, thereby effectively fixing the positions of the first and second connectors 211 and 221 and preventing the performance deterioration.

The radio communication module 200 is manufactured, for example, by the following manufacturing method. First, the circuit device(s) and the first connector 211 for radio connection are disposed on the upper surface of the substrate 210. Further, the shield can 212 is attached to the substrate 210 to cover the circuit device(s).

Next, a soldering process is performed to complete the mounting of the circuit device(s) and the first connector 211 on the substrate 210 and fix of the shield can 212 to the substrate 210. When the soldering process is completed, the second connector 221 of the external patch antenna 220 is connected to the first connector 211 to electrically connect the external patch antenna 220 to the substrate 210.

Finally, the cover 230 is bonded to the upper surface of the shield can 212 to be disposed over the first and second connectors 211 and 221 which are disposed in the connector accommodating space 212a, thereby preventing the first and second connectors 211 and 221 from being separated due to the movement of the cable 222.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A radio communication module, comprising:
a printed circuit board;
an external patch antenna electrically connected to the printed circuit board through connectors and a cable;
a shield can disposed on a surface of the printed circuit board; and
a cover assembled on a surface of the shield can and comprising a connector fixing portion protruding toward the connector.

2. The radio communication module of claim 1, wherein ends of the cover comprise assembling portions which are bent toward the shield can.

3. The radio communication module of claim 1, wherein the cover further comprises a reinforcing portion for reinforcing a strength of the connector fixing portion.

4. The radio communication module of claim 3, wherein the reinforcing portion comprises a rib formed at an outside portion of the connector fixing portion or a raised portion formed at an inside portion of the connector fixing portion.

5. The radio communication module of claim 1, wherein the connectors comprise a first connector disposed on the printed circuit board and a second connector formed on the cable, and the connector fixing portion is configured to limit movement of the second connector.

6. A radio communication module, comprising:
a printed circuit board;
an external patch antenna electrically connected to the printed circuit board through connectors and a cable;
a shield can disposed on a surface of the printed circuit board and having a side including a connector accommodating space in which the connector is disposed; and
a cover attached to a surface of the shield can and covering the connector accommodating space.

7. The radio communication module of claim 6, wherein the connector accommodating space is disposed at a central part of the side of the shield can.

8. The radio communication module of claim 6, wherein the cover is bonded to the shield can by adhesive tape.

9. The radio communication module of claim 6, wherein the connectors comprise a first connector disposed on the printed circuit board and a second connector formed on the cable, and the cover is configured to limit movement of the second connector.
